(19) United States
(12) Patent Application Publication
(10) Pub. No.: US 2003/0110302 A1
(43) Pub. Date: Jun. 12, 2003

(54) Apparatus and method for bridging network messages over wireless networks

(75) Inventors: Steven L. Hodges, Boise, ID (US); Joseph E. Bowen, Greenleaf, ID (US); David K. Poole, Boise, ID (US)

Correspondence Address: FRANK J. DYKAS, DYKAS, SHAVER & NIPPER, LLP, P.O. BOX 877, BOISE, ID, 83701-0877, US

(73) Assignees: Telemetric Corporation, Boise, ID; Idaho Corporation, Boise, ID

(21) Appl. No.: 10/273,817

(22) Filed: Oct. 18, 2002

Related U.S. Application Data
(60) Provisional application No. 60/330,439, filed on Oct. 22, 2001.

(51) Int. Cl. G06F 15/16

(52) U.S. Cl. 709/249; 709/230

(57) ABSTRACT

An apparatus and method for communicating DNP protocol messages across networks that maybe slower, less reliable, and/or bandwidth-cost-constrained are provided. A DNP Bridge server capable of sending/receiving messages to/from a DNP Master System, a DNP Bridge Slave Interface unit capable of sending/receiving DNP message to/from a DNP Slave Device are used. The DNP Bridge server and DNP Bridge Slave Interface act together to transparently link the DNP Master System to the DNP Slave Device over slow, unreliable networks. The DNP Bridge server and DNP Bridge Slave Interface use a combination of techniques to minimize message transmissions and DNP protocol errors over slow, unreliable networks.

### PRIORITY

This application claims the priority of the U.S. Provisional Patent Application Serial No. 60/330,439 filed on Oct. 22, 2001 entitled “System for bridging DNP network messages over, slow, unreliable, bandwidth-cost-constrained networks.”

### BACKGROUND OF THE INVENTION

1. Field of the Invention

The present invention generally relates to wireless bridging of messages within remote monitoring and control systems. More specifically, the invention relates to wireless network systems used to bridge supervisory control and distribution automation systems used by electrical and other utility companies to monitor and control remote equipment.

2. Background Information

Many industries utilize remote mechanical and electrical equipment in their operations. For example, electric power utilities utilize transformers, capacitor banks, voltage regulators, remote generators, and other electronic equipment distributed over a large geographical area. It is desirable for electric power companies to remotely monitor and control their power distribution equipment. Using telemetry to monitor and control power distribution equipment allows the power companies to check the status of, and enable or disable equipment like power transformers that may be miles away from the utility's headquarters.

Presently, the Distributed Network Protocol language, also known as the DNP network protocol standard, allows many different vendors of electrical power distribution and other equipment to communicate with a central monitoring and control system. The DNP network protocol specifies a DNP Master System, also known as a Supervisory Control and Distribution Automation System, or SCADA system, and a limited number of DNP Slave Devices. The DNP Master is typically a console system that allows an operator to view the status of and control equipment in the company's DNP network. The company's DNP network is made up of DNP Slave Devices, typically embedded into or adapted directly to power distribution or other equipment, communicating to the DNP Master System through a network interface.

The DNP Master System and DNP Slave Devices typically use dedicated leased line or dial-up modem line to communicate. Although these communication lines are typically reliable and provide adequate communication bandwidth for this purpose, they are costly to install and operate, especially for equipment that is far from existing telephone lines.

Newer communications technologies are now available that allow data communications using wireless public carrier networks. For example, two national companies currently offer cellular control channel wireless data service that has broad coverage throughout the United States. Typically, the fixed monthly cost for this service is far less than a dedicated leased line from the phone company. However, cellular control channel wireless data service communication bandwidth is significantly lower than that of dedicated leased lines. Cellular control channel data bandwidth is typically tens of bits per minute, while leased line communication bandwidth is typically tens of thousands of bits per second. Additionally, leased line data communications typically allow for very large or even unlimited amounts of data to be transmitted per billing cycle. Cellular control channel data communications becomes cost prohibitive when even modest amounts of data are transmitted in a billing cycle.

In many DNP applications, the majority of DNP network traffic is generated by the DNP Master System frequently polling the DNP Slave Devices for status information that rarely changes. A system is needed to minimize the amount of DNP network traffic generated by these status messages in order to keep the cost of the service low.

Most DNP applications were developed assuming the characteristics of a leased line communications link between the DNP Master System and the DNP Slave Device. That is, a communications link that supports thousands or even tens of thousands of bits per second and that sending a great deal of data over the communications link would not have a significant effect on the cost of the communication link. In fact, the Distributed Network Protocol, as well as most other protocols used with distributed networks, is quite verbose. Therefore, several problems arise when simply replacing a leased line communication link with a slower communication link such as cellular control channel. Many DNP commands sent from the DNP Master System may time-out waiting for a response from the DNP Slave Device because of the slow speed of the underlying data transport mechanism. The DNP protocol allows for packet sizes exceeding 2048 bytes. Many of the slower, less reliable network technologies support maximum packet sizes significantly smaller than 2048 bytes.

A system is needed that can bridge DNP messages using a slower, and perhaps unreliable network, such as a cellular phone system, that would otherwise cause time-out errors to occur in equipment originally designed for use with leased telephone lines.

In a DNP network, a control message is sometimes sent to a group of DNP Slave Devices simultaneously. A system is needed to “broadcast” the control message to the DNP Slave Device group with minimum network traffic.

FIG. 1 shows how the prior art typically communicates messages in a DNP network. The DNP Master System 1 communicates a DNP message over Local Area Network 2 to a modem multiplexer 3. Modem multiplexer 3 sends the message via one or more dedicated or dial-up modem lines 4 to the ‘dumb’ modem 5. Typically, a serial interface 6 is used to send the message from ‘dumb’ modem 5 to the DNP Slave Device 7. Return messages are sent in a reciprocal manner from the DNP Slave Device 7 back to the DNP Master System 1.

The existing leased line based data communications afford a certain amount of security in a DNP network system. That is, a potential attacker would typically need to physically tap into a physical phone company line to covertly monitor or control a DNP slave device. Monitoring or controlling many DNP devices simultaneously becomes even more difficult. Transmitting DNP network messages over the Internet or wireless networks opens the doorway to attackers that are not physically near the DNP network. The Internet or wireless networks potentially allow the attacker to target many DNP devices simultaneously. A system is needed to ensure that the DNP Master System can be sure it is communicating with authorized DNP Slave Devices and DNP Slave Devices are communicating with authorized DNP Masters Systems. The prior art does not provide a mechanism for encrypting or authenticating messages sent in a DNP network.

Additionally, DNP Master Systems are very expensive to install and maintain. Some smaller companies have not been able to justify the expense of a full DNP Master System. Yet many companies have already invested in equipment that supports the DNP. Adding an Internet web-based user interface to the invented DNP Bridge server could provide smaller companies with many of the benefits of a full DNP Master System, at a much lower cost.

The prior art is limited in scope because it does not provide for a means to address the limitations of using wireless networks that may be slower, less reliable or otherwise incompatible with existing DNP networks. The prior art does not include mechanisms to ensure that, among other problems, the DNP master does not generate an excessive amount of traffic over the DNP network and that the DNP master, or DNP slave devices do not generate excessive DNP message timeouts, potentially “thrashing” the DNP network.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

Accordingly, it is an object of the present invention to provide a system for reliably communicating DNP messages between a DNP Master System and a DNP Slave Device over networks that may be slower, less reliable, data transfer rate or bandwidth-constrained, or cost constrained. It is another object of the invention to provide a system for communicating DNP messages sent to or from a DNP Master System via an invented DNP Bridge server, to or from DNP Slave Devices via an invented DNP Slave Interface unit. It is another object of the invention to minimize the changes to the DNP Master System and DNP Slave Devices to work with the inventive system.

It is a further object of the present invention to provide a web-based or other user interface to the DNP Bridge server for directly monitoring and controlling the DNP Slave Devices.

It is another object of the invention to provide a system for minimizing the amount of traffic transmitted over the portion of the network that may be slow, unreliable, and bandwidth-cost-constrained between a DNP Master Device and a DNP Slave Device.

It is another object of the invention to provide a system for securing and authenticating communications between DNP devices.

It is another object of the invention to provide a system for grouping DNP Slave Devices and providing a system for sending messages to all devices in the group with a minimum amount of network traffic.

These objects are achieved by use of a first bridging device which is interconnected to the distributed network master system and is capable of wireless communication, typically through the control channels of a commercial cellular phone network with a number of second bridging devices. The second bridging devices are, in turn, interconnected to the various slave devices of the distributed network. The bridging devices use the original preexisting distributed language protocol to communicate with the various distributed network devices, and a second language protocol, which is far more compact, condensed or compressed to communicate over the control channels of the cellular phone network between the various bridging devices.

The second bridging devices are programmed to only pass on certain information from the slave devices to the first bridging device. Such things as routine reports of unchanged status or condition of the equipment being monitored by the slave devices are not routinely passed on by the second bridging devices. Instead, by using combinational logic, the second bridging devices will only transmit those conditions or signals that are necessary to properly monitoring the condition of the various pieces of equipment being monitored. For example, reports will be sent to the first bridging device in the event of a change in equipment status or a change in a monitored parameter value for which a report is required. The information transmitted to the first bridging device is cached therein and used as the data for communication with the distributed network master system when it is responding to the network master system, for example, responding to routine, timed, status inquiries.

The first bridging device is designed to emulate the various distributed network slave devices in its communications with the distributed network master system, and responding with the cached information that it receives from the second bridging devices. The first bridging device only sends a communication to the second bridging devices when, in accordance with its preprogrammed logic that establishes the criteria for when to communicate, it is necessary. In this manner, the amount of data transferred between the various bridging devices over the cellular phone network is minimized. This, in turn, allows for the use of a wireless network, which has a slower, lower capacity, data transmission rate, as a communication medium in a distributed network that uses a language protocol designed for use with a communication medium having much higher data transmission rates and capacity, typically that of a dedicated phone line.

The information and commands that are passed from the first bridging device to the various secondary bridging devices, when received by the second bridging devices, is decoded and translated back into the original distributed network protocol language and sent to the appropriate network slave device. In this manner, the secondary bridging devices emulate and appear as the original network master system to the slave devices.

Various encryption systems may be employed to protect and authenticate the various communications being sent over the airwaves on the public cellular network.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 shows how the prior art typically communicates messages in a DNP network.

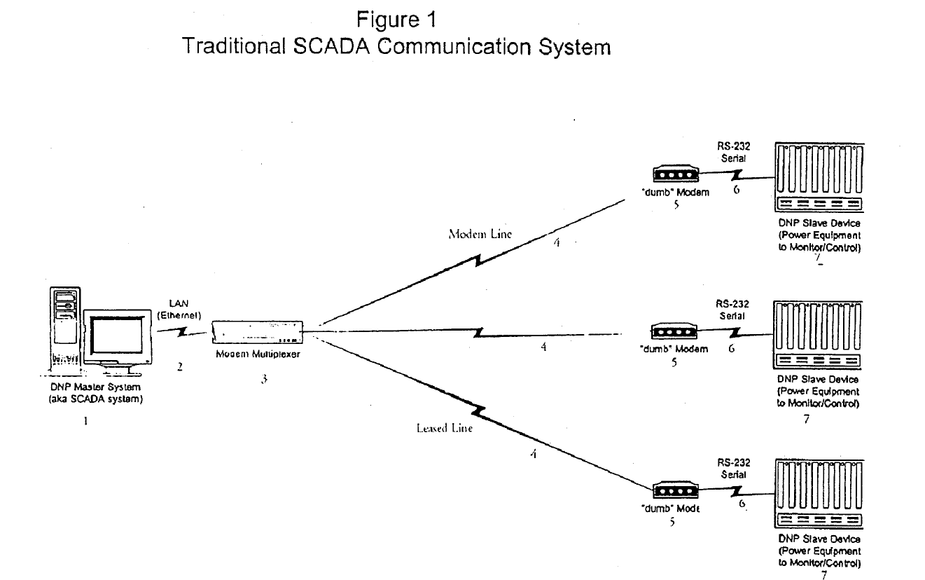

FIG. 2 shows how the present invention system typically communicates messages in a DNP network.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The invention is presented here in the context of usage with a typical Supervisory Control and Distribution Automation System, or SCADA system, which uses Distributed Network Protocol language, or DNP, which is typical of those used by electric utility companies in conjunction with power distribution systems. However, it should be distinctly understood that the invented system can be used in virtually any distributed control network, for example, natural gas distribution systems, water and other utility systems, and many other types of systems, such as heating and ventilation systems for large building complexes, and the like. The invented system will generally work well with any distributed network system wherein there is a centralized control system and a number of dispersed networks of slave systems for either reporting status and/or parameters, or functioning as remote control units.

The present invention, in the context of a SCADA system utilizing DNP network devices, employs a first bridging device, herein called the DNP Bridge Server, a second bridging device, hereinafter call the DNP Bridge Slave Interface, a highly condensed or compressed transmission format message system, and a collection of software algorithms to achieve the objects of the invention.

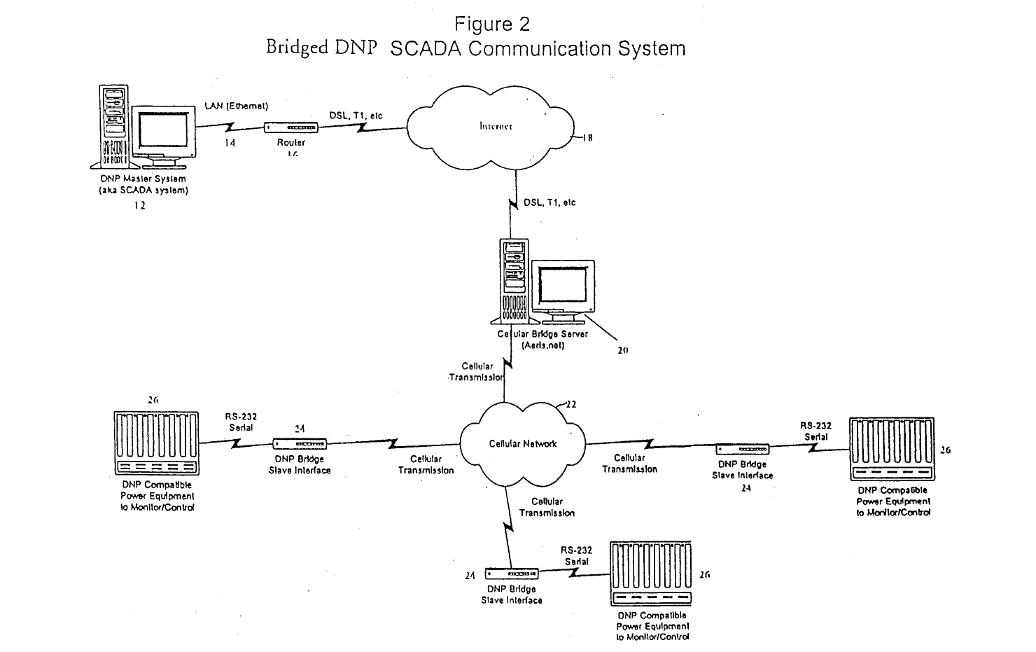

FIG. 2 shows, in general terms, how the invented system typically communicates messages within a DNP network. The first or primary DNP network device is the DNP Master System 12. It communicates DNP messages over Local Area Network 14 to router 16. Router 16 sends the DNP messages via the Internet 18, or a dedicated line, to the DNP Bridge Server 20. DNP Bridge Server 20 forms a transmission formatted message and sends the new message via a cellular transmission to the Cellular Bridge Server 22 of the publicly available cellular transmission service being used. Cellular Bridge Server 22 then transmits the transmission formatted message over the cellular network to the invented DNP Bridge Slave Interface 22. DNP Bridge Slave Interface 22 then translates the transmission formatted message back into its original DNP message and sends it via a serial interface to the other network devices which are typically DNP′ Slave Devices 24.

In the inventive system, to the appearance of the DNP Master System, the DNP Bridge Server emulates as the DNP Slave Device. To the appearance of the DNP Slave Device, the DNP′ Slave Interface unit emulates as the DNP Master System. In the prior art, the DNP Master System sends DNP messages through a series of “dumb” communications links (i.e. LAN, Modem Multiplexer, leased line, modem) directly to the DNP Slave Device. In the present invention system, the DNP Bridge Server is capable of acting as the DNP Slave Device. Conversely, the DNP Slave Interface unit is capable of acting as the DNP Master System. Through this means, many additional benefits can be realized, not the least of which is that the amount of information being sent back and forth between the DNP Master System and the DNP Slave Device is minimized, thus reducing costs and bandwidth capacity requirements.

Typically, the DNP Master System will poll the DNP Slave Devices regularly with DNP Status request messages. It is either looking for information concerning the status of the monitored equipment, such as which switches are closed and which are open, or parameter values, such as what is the voltage or current load, at a certain location. The DNP Master System is looking for changes in the status of the DNP Slave Devices that may be indicative of an alarm condition. Often, the data sent back by the DNP Slave Devices does not change. In the inventive system, the DNP Master System will poll the DNP Bridge Server for DNP Slave Device input status. Instead of relaying the DNP Status Message across the bandwidth-cost-constrained portion of the network, the DNP Bridge Server will return status values cached from the last time the DNP Slave Interface unit sent status information. Since, as will be later explained, the DNP Slave Interface unit only sends a wireless message upon the occurrence of a change in either status or parameter values that it is programmed with combination logic to recognize, the last cached status and parameter values will be accurate.

More specifically, in the inventive system, the DNP Bridge Server and the DNP Bridge Slave Interface use a combination of transmission format messages, caching of data, and combinational logic to minimize the amount of data transferred over the bandwidth-cost-constrained portion of the network. At initialization, the DNP Slave Interface unit retrieves all of the DNP Slave Device's input values via a DNP status request message. The DNP Slave Interface saves these values and sends a copy of the values to the DNP Bridge Server. Additionally, at initialization, the DNP Slave Interface unit is programmed with combinational logic, similar to the logic used in the DNP Master System to trigger an alarm on the console. Examples of typical combination logic sequences are as follows: for a binary change event—if a given input value changes from one to zero, or zero to one, for a configurable period of time, the event is triggered; for an analog change event—if the analog input value moves from one configured range, either fixed, stair stepped or computer moving average, to another for a configurable period of time, the event is triggered; and for time scheduled events—the current value for one or more inputs is transmitted on a configurable time schedule.

For example, assume the DNP Master System is programmed to trigger an alarm condition on the console when a DNP Slave Device's input exceeds twenty-five percent (25%) of its normal value. In this case, the DNP Slave Interface unit might be programmed to poll the DNP Slave Device once per minute. If the DNP Slave Interface unit detected that any of the DNP Slave Device's inputs had exceeded twenty-five percent (25%) of their normal value, the DNP Bridge Slave Interface unit will send a transmission format asynchronous status update message to the DNP Bridge Server. The next time the DNP Master System polls the DNP Bridge Server, it will receive the updated status condition and signal an alarm on the console.

Some DNP messages will need to be passed from the DNP Master System down to the DNP Slave Device for a synchronous response. In this case, problems may arise due to the significant reduction in bandwidth in the slower wireless network. DNP Master Systems are typically programmed to “time-out” a message if a response is not received after a short period of time. Typically, the DNP Master System will retry sending the message. Additionally, DNP messages contain a significant amount of extraneous information that consumes extra space in the network message.

In the inventive system, the DNP Bridge Server and the DNP Bridge Slave Interface work together to minimize the effects of the limited bandwidth availability and minimize the amount of data transferred over the slow portion of the network. Considering first the case where no time-outs are encountered: when a DNP message to be sent to the DNP Slave Device arrives at the DNP Bridge Server, the following steps are taken: the message is encoded into a smaller transmission format message; if necessary, the message is broken up into smaller network messages that match the underlying transport mechanism packet size; the message type being sent, its source and destination addresses and the state of the message sending process is saved; a timer is started to watch for the response to the transmission format message; and finally the message transmission process is started.

When the DNP Bridge Slave Interface unit receives the entire message, the transmission format message is decoded into the original DNP message and sent to the DNP Slave device. The DNP Slave device then sends the DNP response message back to the DNP Slave Interface unit. When the DNP response is received, the DNP Bridge Slave Interface Unit builds a transmission format response message, and, if necessary, breaks the message up into smaller network messages that match the underlying transport mechanism size, and sends it back to the DNP Bridge Server. When the DNP Bridge Server receives the transmission format response message, it decodes the message into a DNP response message, sends the message back to the DNP Master System and clears its state and timer information of the message.

If the DNP Master System times-out waiting for the response from the DNP Bridge Server, the DNP Master System will typically resend the DNP message. When the DNP Bridge Server receives the retransmission of the DNP message, it searches its saved DNP message state information, and when the match is found, it sends the retransmitted DNP message. This mechanism prevents “thrashing” of the low bandwidth portion of the network.

If the DNP Bridge Server's timer expires for the transmission format message, the DNP Bridge Server deletes the message state information. This mechanism allows the DNP Master System's subsequent retries of the DNP message to pass through in the event that the transmission message transfer times-out.

It is often desirable to be able to send a group of DNP Slave Devices a DNP control message simultaneously. Additionally, it would be desirable to minimize the amount of data sent over the bandwidth-cost-constrained portion of the DNP network. In the inventive system, when the bandwidth-cost-constrained portion of the DNP network uses technology in which all nodes “hear” all network traffic, a specially formatted “group broadcast command message” is employed. At initialization, a group address is programmed into the DNP Bridge Slave Interface unit. When the DNP Bridge Slave Interface unit “hears” a group or specially formatted message addressed to the group address, the DNP Bridge Slave Interface unit will respond to this message.

By moving part or all of the DNP messages across public networks, the DNP network system becomes more vulnerable to attack. DNP Slave Devices often control equipment that is part of the public power grid. Unauthorized access to DNP Slave Devices could cripple the power network, affecting thousands of businesses and residences. Strong authentication between the DNP Master System and the DNP Slave Device is necessary to prevent such attacks. Encrypting messages between the DNP Master System and the DNP Slave Device may also be desirable in applications where knowledge of the DNP message contents may be helpful to an attacker or even a competitor.

The inventive DNP network system consists of potentially several different network mediums with different bandwidth, reliability, and cost characteristics. Many different authentication and encryption technologies exist, each placing unique demands on the underlying network infrastructure. In the inventive system, authentication and encryption technologies are deployed to match the characteristics of the network transport and the associated risk of the transport. For example, in one embodiment, messages sent between systems in the DNP Network that are connected via high bandwidth, non-cost constrained networks may use an IPSEC VPN tunnel to communicate messages. IPSEC VPN tunnels can provide a very high level of authentication and encryption, but require a significant amount of bandwidth overhead. For messages sent over the slow, unreliable, bandwidth-cost-constrained portion of the DNP network, other authentication and encryption technologies may be needed. For example, in one embodiment, messages sent over the slow portion of the network use a time-synchronous sequence generator to authenticate the message sender.

To minimize the time and costs associated with installation of the inventive network transport mechanisms in an existing DNP network, one embodiment of the present invention system provides interfaces to the DNP Master System and DNP Slave Device that are compatible with their existing network interfaces. DNP Master Systems are sometimes configured to communicate through a network terminal server to send messages through modems to the DNP Slave Devices. In one embodiment of the DNP Bridge Server, the present invention system emulates the network terminal server. The present invention system works with the existing DNP Master System by simply changing the address of the DNP Master System's network terminal server to the address of the DNP Bridge Server. Also, it should be noted that if the DNP Master System is connected to the DNP Bridge Server via the Internet, a single high capacity DNP Bridge Server may serve as the first bridging device for multiple separate networks at the same time and only be limited by its hardware capacity.

DNP Slave Devices may be configured to communicate DNP network protocol directly over an RS-232 serial interface to an AT-compatible modem. In one embodiment of the DNP Bridge Slave Interface unit, the inventive system emulates an AT-compatible modem. The inventive system works with the existing DNP Slave Device directly.

The present invention is not limited in scope to the DNP protocol, rather any data acquisition protocol, including but not limited to Modbus, GPIB, IEC 60870-5 and others. Modifications to the above description that include that which is known in the art are well within the scope of the contemplated invention. For example, multiple formats of incoming and outgoing messages are contemplated as included within the scope of the invention.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. An apparatus for bridging one device in a network to one or more other devices in the network using wireless transmission which comprises:
a first bridging device adapted for installation in the network and configured to receive and send information, in a first language protocol from and to a first network device and to send and receive all or part of the information in a second language protocol, by wireless communication, to a second bridging device; and
said second bridging device adapted for installation in the network and configured to receive and send information, in the first language protocol from and to one or more second network devices and to send and receive all or part of the information in said second language protocol, by wireless communication, to the first bridging device.

2 An apparatus for bridging one device in a network to one or more other devices in the network using wireless transmission which comprises:
a first bridging device adapted for installation in the network and configured to receive and send information, in a first language protocol, at a first data transmission rate, from and to a first network device and to send and receive all or part of the information in a second language protocol, as bits of information by wireless communication, at a second data transmission rate, to a second bridging device; and
said second bridging device adapted for installation in the network and configured to receive and send information, in the first language protocol, at said third data transmission rate, from and to one or more second network devices and to send and receive all or part of the information in said second language protocol, as bits of information by wireless communication, at said second data transmission rate, to the first bridging device.

3. The apparatus of claim 2 wherein the second language protocol further comprises a language protocol wherein the number of bits required to contain a specific amount of information to be transmitted is less than the number of bits required in the first language protocol to contain the same amount of information.

4. An apparatus for bridging one device in a network to one or more other devices in the network using wireless transmission which comprises:
a first bridging device adapted for installation in the network and configured to receive and send information, in a first language protocol from and to a first network device and to selectively send and receive portions of the information in a second language protocol, by wireless communication, to a second bridging device; and
said second bridging device adapted for installation in the network and configured to receive and send information, in the first language protocol from and to one or more second network devices and to selectively send and receive portions of the information in said second language protocol, by wireless communication, to the first bridging device.

5. An apparatus for bridging one device in a network to another device in the network, wherein each of said network devices is capable of communication using the same communications protocol language, using wireless transmission, which comprises:
a first bridging device adapted for installation in the network and configured to receive and send information, in a first language protocol from and to a first network device and to send and receive all or part of the information in a second language protocol, by wireless communication, to a second bridging device, and further configured to emulate the second network device when communicating with the first network device; and
said second bridging device adapted for installation in the network and configured to receive and send information, in the first language protocol from and to one or more second network devices and to send and receive all or part of the information in the second language protocol, by wireless communication, to the first bridging device, and further configured to emulate the first network device when communicating with the second network device.

6. The apparatus of claims 1, 2, 3 or 4 wherein the first bridging device is further configured to emulate the second one or more network devices when receiving and sending information from and to the first network device.

7. The apparatus of claims 1, 2, 3 or 4 wherein the second bridging device is further configured to emulate the first network device when receiving and sending information from and to the one or more second network devices.

8. The apparatus of claim 7 wherein the first bridging device is further configured to emulate the second one or more network devices when receiving and sending information from and to the first network device.

9. The apparatus of claims 1, 2, 3, 4 or 5 wherein the information sent and received between the second bridging device and the one or more second network devices may include one or more of the following categories of information selected from the group of: status inquiries; parameter inquiries; status changes; parameter changes; instructions to change configuration of equipment; and instructions to not change configuration of equipment.

10. The apparatus of claim 9 wherein the second bridging device is configured to utilize at least one logic step to determine what information is sent in the second language protocol, by wireless transmission, to the first bridging device.

11. The apparatus of claims 1, 2, 3, 4 or 5 wherein the information sent and received between the first bridging device and the second bridging network device may include one or more of the following categories of information selected from the group of: status inquiries; parameter inquiries; status changes; parameter changes; instructions to change configuration of equipment; and instructions to not change configuration of equipment.

12. The apparatus of claim 11 wherein the first bridging device is configured to utilize at least one logic step to determine what information is sent in the second language protocol, by wireless transmission, to the second bridging device.

13. The apparatus of claim 11 wherein the information sent and received between the second bridging device and the first bridging device may include one or more of the following categories of information selected from the group of: status inquiries; parameter inquiries; status changes; parameter changes; instructions to change configuration of equipment; and instructions to not change configuration of equipment.

14. The apparatus of claim 13 wherein the second bridging device is configured to utilize at least one logic step to determine what information is sent in the second language protocol, by wireless transmission, to the first bridging device.

15. The apparatus of claims 1, 2, 3, 4 or 5 wherein said second language protocol is encrypted.

16. The apparatus of claims 1, 2, 3, 4 or 5 wherein said wireless transmission is by cellular phone.

17. The apparatus of claim 12 wherein said wireless transmission utilizes cellular phone control coding to transmit information.

18. The apparatus of claims 1, 2, 3, 4 or 5 wherein said wireless transmission utilizes a communications satellite to transmit information.

19. A method for bridging one device in each of a plurality of networks to one or more other devices in the same network using wireless transmission which comprises:
utilizing a first bridging device adapted for installation to a first device in each the plurality of networks and configured to receive and send information, in a first language protocol from and to each of the first network devices and to send and receive all or part of the information in a second language protocol, by wireless communication, to any of a plurality of second bridging devices;
utilizing said second bridging devices adapted for installation in each of the networks and configured to receive and send information, in the first language protocol from and to one or more second network devices in each of the plurality of networks and to send and receive all or part of the information in said second language protocol, by wireless communication, to the first bridging device; and
utilizing the first bridging device to route information received from the plurality of second bridging devices to the first network device in the same network.

20. A method for bridging one device in a network to one or more other devices in the network using wireless transmission which comprises:
utilizing a first bridging device adapted for installation in the network and configured to receive and send information, in a first language protocol from and to a first network device and to send and receive all or part of the information in a second language protocol, by wireless communication, to a second bridging device; and
utilizing said second bridging device adapted for installation in the network and configured to receive and send information, in the first language protocol from and to one or more second network devices and to send and receive all or part of the information in said second language protocol, by wireless communication, to the first bridging device.

21. A method for bridging one device in a network to one or more other devices in the network using wireless transmission which comprises:
utilizing a first bridging device adapted for installation in the network and configured to receive and send information, in a first language protocol, at a first data transmission rate, from and to a first network device and to send and receive all or part of the information in a second language protocol, as bits of information by wireless communication, at a second data transmission rate, to a second bridging device; and
utilizing said second bridging device adapted for installation in the network and configured to receive and send information, in the first language protocol, at said first data transmission rate, from and to one or more second network devices and to send and receive all or part of the information in said second language protocol, as bits of information by wireless communication, at said second data transmission rate, to the first bridging device.

22. The method of claim 21 which further comprises using a second language protocol wherein the number of bits required to be transmitted to contain a specific amount of information is less than the number of bits required in the first language protocol to contain the same amount of information.

23. A method for bridging one device in a network to one or more other devices in the network using wireless transmission which comprises:
utilizing a first bridging device adapted for installation in the network and configured to receive and send information, in a first language protocol from and to a first network device and to selectively send and receive portions of the information in a second language protocol, by wireless communication, to a second bridging device; and
utilizing said second bridging device adapted for installation in the network and configured to receive and send information, in the first language protocol from and to one or more second network devices and to selectively send and receive portions of the information in said second language protocol, by wireless communication, to the first bridging device.

24. A method for bridging one device in a network to another device in the network, wherein each of said network devices is capable of communication using the same communications protocol language, using wireless transmission, which comprises:
utilizing a first bridging device adapted for installation in the network and configured to receive and send information, in a first language protocol from and to a first network device and to send and receive all or part of the information in a second language protocol, by wireless communication, to a second bridging device, and further configured to emulate the second network device when communicating with the first network device; and
utilizing said second bridging device adapted for installation in the network and configured to receive and send information, in the first language protocol from and to one or more second network devices and to send and receive all or part of the information in the second language protocol, by wireless communication, to the first bridging device, and further configured to emulate the first network device when communicating with the second network device.

25. The methods of claims 19, 20, 21, 22, or 23 which further comprises configuring the first bridging device to emulate the second one or more network devices when receiving and sending information from and to the first network device.

26. The method of claims 19, 20, 21, 22, or 23 which further comprises configuring the second bridging device to emulate the first network device when receiving and sending information from and to the one or more second network devices.

27. The method of claim 26 which further comprises configuring the first bridging device to emulate the second one or more network devices when receiving and sending information from and to the first network device.

28. The method of claims 19, 20, 21, 22, 23 or 24 which further comprises selecting the information sent to and received from the second bridging device and the one or more second network devices from one or more of the following categories of information from the group of: status inquiries; parameter inquiries; status changes; parameter changes; instructions to change configuration of equipment; and instructions to not change configuration of equipment.

29. The method of claim 28 which further comprises configuring the second bridging device to utilize at least on logic step to determine what information is sent in the second language protocol, by wireless transmission, to the first bridging device.

30. The method of claims 19, 20, 21, 22, 23 or 24 which further comprises selecting the information sent to and received from the first bridging device and the second bridging device from one or more of the following categories of information from the group of: status inquiries; parameter inquiries; status changes; parameter changes; instructions to change configuration of equipment; and instructions to not change configuration of equipment.

31. The method of claim 30 which further comprises configuring the first bridging device to utilize at least on logic step to determine what information is sent in the second language protocol, by wireless transmission, to the second bridging device.

32. The method of claim 30 which further comprises selecting the information sent to and received from the second bridging device and the first bridging device from one or more of the following categories of information from the group of: status inquiries; parameter inquiries; status changes; parameter changes; instructions to change configuration of equipment; and instructions to not change configuration of equipment.

33. The method of claim 32 wherein the second bridging device is configured to utilize at least on logic step to determine what information is sent in the second language protocol, by wireless transmission, to the first bridging device.

34. The method of claims 19, 20, 21, 22, 23 or 24 which further comprises encrypting the second language protocol.

35. The method of claims 19, 20, 21, 22, 23 or 24 which further comprises transmitting wireless transmission by cellular phone.

36. The method of claim 30 which further comprises using the cellular phone control coding to transmit information.

37. The method of claims 19, 20, 21, 22, 23 or 24 which further comprises using a communications satellite for wireless transmission.
